(19) United States
(12) Patent Application Publication
(10) Pub. No.: US 2006/0007149 A1
(43) Pub. Date: Jan. 12, 2006

(54) Ergonomic pointing device

(76) Inventor: Kimberly L. Miller, Waconia, MN (US)

Correspondence Address: John F. Klos, Esq.;Fulbright & Jaworski L.L.P., Suite 2100, 80 South Eighth Street, Minneapolis, MN, 55402-4320, US

(21) Appl. No.: 10/890,503

(22) Filed: Jul. 12, 2004

(51) Int. Cl. G09G 5/08

(52) U.S. Cl. 345/163

(57) ABSTRACT

A pointing device which enables the palm of a hand to rest upon the top portion in a relaxed position. A protuberance is positioned to engage confronting sides of both the index and middle finger. As such, there is no need to grip the pointing device, and the pointing device is able to be manipulated by simply moving the larger forearm muscles. A flat surface maintains the pointing device in a generally upright position, alleviating the need for the wrist to balance the pointing device during its use. These features significantly reduces stress and strain on the more delicate hand and wrist muscles.

### FIELD OF THE INVENTION

The present invention relates to a pointing device (mouse) for control of cursor movements on a display. More particularly, the present invention concerns a pointing device ergonomically designed to minimize repetitive stress injuries.

### BACKGROUND OF THE INVENTION

A pointing device, otherwise known as a mouse, is commonly used to direct the movement of a cursor on a computer display. The pointing device is typically used in order to specify a location on a computer display or to control the operation of applications and program in operating systems utilizing a graphical user interface. Typically, the pointing device is manipulated on a desk top and this movement is translated as movement of a cursor on a computer display. The pointing device will also typically include a selection mechanism, typically a button, which is used to indicate where an action is to be performed or which is used to activate programs and applications.

Positioning a cursor on a computer display will typically involve moving a pointing device on a flat surface and having this movement translated by the computer system into an equivalent movement of the cursor on the graphic display. This translation is typically implemented by using a trackball mechanism comprised of a ball and a pair of rollers, each roller corresponds to an axis along a two dimensional plane (x or y). Movement of the pointing device causes a rotational movement in the ball, and this rotational movement is translated by each roller as movement along its respective axis. The cursor is then depicted on the display as performing a corresponding movement.

Typically, once a cursor has been positioned at a particular location or upon an icon or an application, a selection mechanism is activated in order to instruct the computer system to perform a function at the location or with respect to the selected icon or application. A typical pointing device will have a selection mechanism comprised of a button coupled to a pressure switch. The button is typically located at the surface of the top portion of the pointing device, and is activated by pressing downward with a finger.

Operating a pointing device often requires extensive movement of the wrists and fingers. In addition, common embodiments of pointing devices often require unnatural flexion of wrists and fingers. When done repeatedly, these actions create static muscle loading and physical stress in the wrist and fingers which fatigue the hand of a user. Continual use of known pointing devices can also lead to repetitive-stress injuries such as carpal tunnel syndrome.

Consequently, there is a need in the art for a pointing device which will reduce the amount of motion and unnatural flexion of the wrists and fingers.

### SUMMARY OF THE INVENTION

In light of the drawbacks of the prior art, the present invention concerns a pointing device adapted to minimize unnatural flexion and movement of the wrist and fingers. The pointing device is comprised of a body with a top portion and a bottom portion. The top and bottom portions cooperate to define an internal space within the body.

In one embodiment, the top portion is a generally rounded surface and is sized to accommodate a user's palm. A protuberance comprised of a wall portion and a tongue portion extends longitudinally along the top portion. The wall portion is curved to engage confronting sides of adjacent fingers. The tongue portion extends from the protuberance and functions to retain the fingers in an engaged position with respect to the wall portion.

In one embodiment, the present invention includes a scroll wheel positioned adjacent to a user's thumb. The scroll wheel rotates about an axis which is generally perpendicular to the top portion, with the wheel being generally parallel to the bottom portion.

In one embodiment, the present invention includes a bottom portion comprised of a generally flat surface and a generally rounded surface. The flat surface is positional in a central region of the bottom portion and is generally oval shaped. The rounded surface peripherally surrounds the flat surface and is comprised of a left section and a right section.

In one embodiment, a selection mechanism is coupled to the rounded surface and a cursor positioning mechanism is coupled to the flat surface. The selection mechanism includes separate pressure switches coupled to each of the left and right sections. The cursor positioning mechanism includes a track ball mechanism.

The present invention alleviates the need to grip the pointing device by enabling it to be manipulated by simply moving the larger forearm muscles. To activate the selection mechanism, the user rotates the forearm causing the subject pointing device to roll onto the right or left rounded section. This eliminates the need to use independent finger movements to activate the selection mechanism and minimizes wrist movement. Engaging confronting sides of both the index and middle finger the protuberance enables the forearm to guide the direction of the pointing device and minimizes wrist movement. The palm of a hand is able to rest upon the top portion in a relaxed position while the pointing device is being manipulated by the forearms.

### BRIEF DESCRIPTION OF THE DRAWINGS AND FIGURES

For purposes of facilitating and understanding the subject matter sought to be protected, there is illustrated in the accompanying drawings an embodiment thereof. From an inspection of the drawings, when considered in connection with the following description, the subject matter sought to be protected, its construction and operation, and many of its advantages should be readily understood and appreciated.

FIG. 1 is a perspective view of one embodiment of the present invention.

FIG. 2 is a side view of the embodiment of FIG. 1.

FIG. 3 is an overhead plan view of the embodiment of FIG. 1.

FIG. 4 is a bottom plan view of the embodiment of FIG. 1.

FIG. 5 is an overhead view of the embodiment of FIG. 1 engaged by a user's hand.

### DETAILED DESCRIPTION

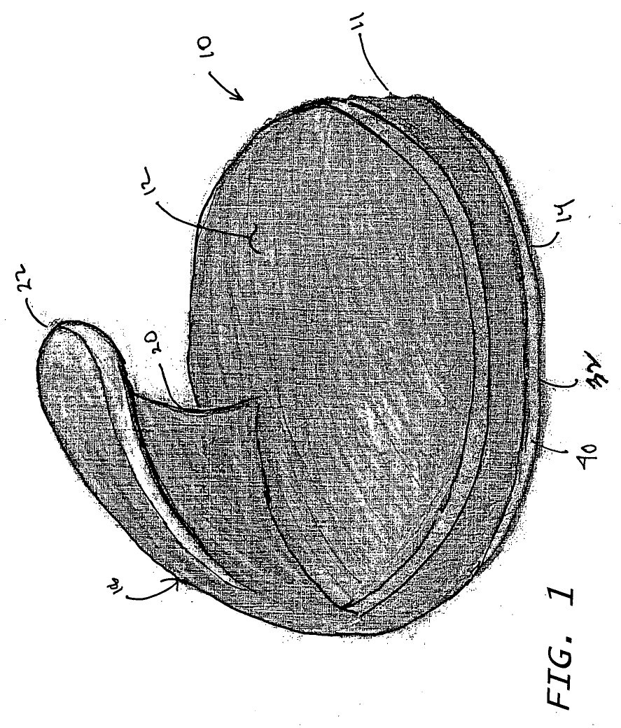

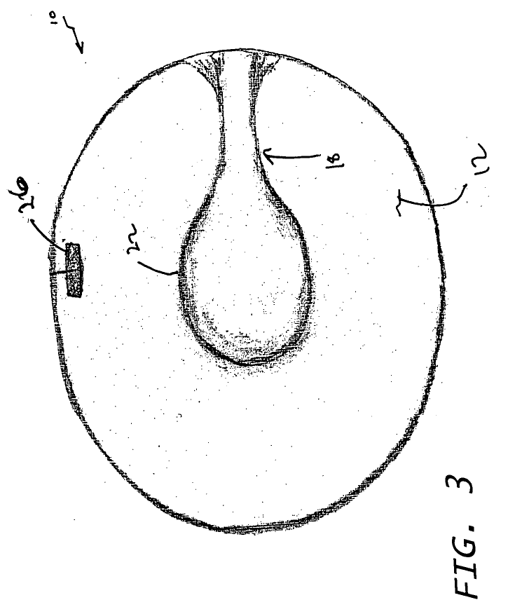

As shown in FIGS. 1, 2, and 3, the present invention concerns a pointing device 10 adapted to minimize movement and unnatural flexion of the wrist and fingers. The pointing device is comprised of a body 11 with a top portion 12 and a bottom portion 14. The top 12 and bottom 14 portions cooperate to define an internal space within the body 11 in which components of the pointing device are located.

In one embodiment, the top portion 12 is a generally rounded surface and sized to accommodate and support a user's palm. The top portion 12 may include ergonomically positioned structures such as depressions, ridges, and raised surfaces in order to better accommodate the fingers and palm. The top portion 12 can also have padded materials affixed thereto in order to minimize pressure points on the hand. Padding materials, such as a gel pack or pad, can be provided at top portion 12. In another embodiment of the invention, a gel pad may be adhesively secured to the top portion 12.

In one embodiment, a protuberance 18 extends longitudinally along the top portion 12. The protuberance is comprised of a wall portion 20 and a tongue portion 22. The wall portion 20 is curved in order to comfortably engage confronting sides of adjacent fingers. The tongue portion 22 extends from the wall portion and is adapted to retain adjacent fingers in an engaged position with respect to the wall portion. The edges of the tongue portion 22 may also be curved in order to better retain an engaged finger. Preferably, the protuberance 18 is positioned to engage confronting surfaces of the middle and index fingers.

In one embodiment, the present invention includes a scroll wheel 26 extending through the top portion 12. The scroll wheel utilizes known hardware and software to interface with the scrolling functions of known applications. The scroll wheel 26 is positioned adjacent to a user's thumb and is adapted to rotate about an axis which is generally perpendicular to the top portion; the scroll wheel 26 is generally parallel to the bottom portion.

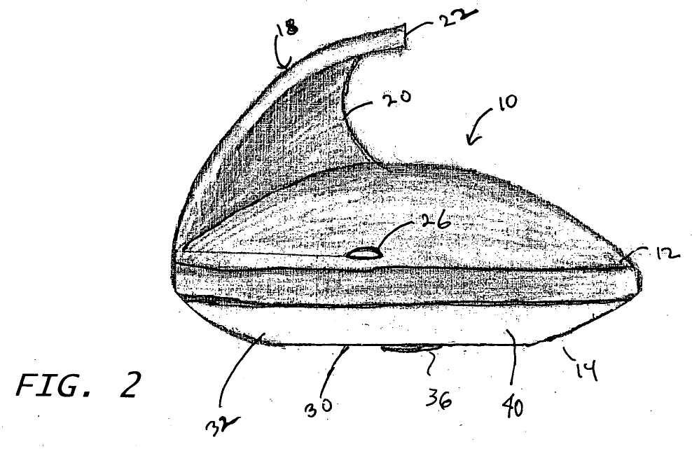

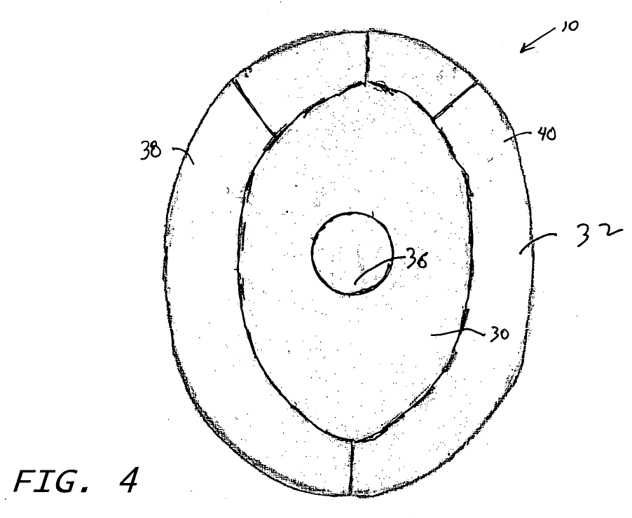

As shown in FIGS. 2 and 4, in one embodiment, the present invention includes a bottom portion 14 comprised of a generally flat/planar surface 30 and a generally rounded surface 32. A selection mechanism (not shown) is coupled to the rounded surface 32 and a cursor positioning mechanism 36 is coupled to the flat surface 30. The bottom portion 14 is generally frusto-spheroidal shaped enabling the pointing device 10 to maintain a stable upright position when not being used.

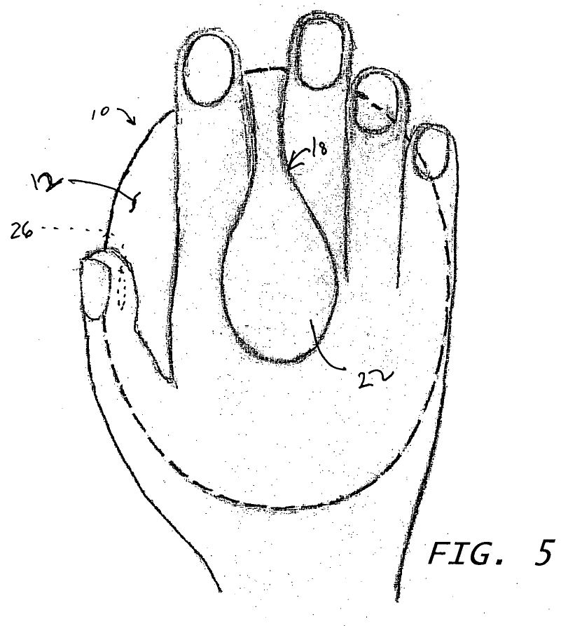

As shown in FIG. 5, in one embodiment the flat surface 30 is positional in a central region of the bottom portion 14 and is generally oval shaped. The flat surface 30 comprises roughly 50% or more of the surface area of the bottom portion 14. As such, the flat surface 30 forms a generally stable base, maintaining the present invention in an upright position during and after its use.

The cursor positioning mechanism 36 is located in the flat surface 30. In one embodiment, the cursor positioning mechanism includes a track ball mechanism. Typically, the track ball mechanism includes a ball which extends partially through the flat surface 30 and rollers (not shown) located within the pointing device 10. The rollers engage the ball and translates the rotation of the ball into movements along a two-dimensional plane (x and y axis). The track ball mechanism and its associated software can be one which is known in the art. It has also been contemplated that other known cursor positioning mechanisms such as magnetic mechanisms and optical mechanisms be implemented.

In one embodiment, the bottom portion 14 includes a rounded surface 32 which peripherally surrounds the flat surface 30. The rounded surface is comprised of a left section 38 and a right section 40. A spring mechanism (not shown) is coupled to an interior surface of each of the left 38 and right 40 sections. The spring mechanism supports each section and enables each to independently and resiliently travel in a direction generally perpendicular to the flat surface 30.

In one embodiment, each of the left 38 and right 40 sections are coupled to a selection mechanism disposed within the pointing device. The selection mechanism cooperates with hardware and software that is known in the art and which enables the selection mechanism to interface with known graphical user interfaces. Preferably, the selection mechanism includes separate pressure switches coupled to each of the left and right sections. The pressure switches are closed/opened when its respective section travels a sufficient distance. Alternatively, a pressure switch may partially extend from each of the right and left sections.

As shown in FIG. 5, the present invention enables the palm of a hand to rest upon the top portion in a relaxed position. In one embodiment, the protuberance is positioned to engage confronting sides of both the index and middle finger. As such, there is no need to grip the pointing device, and the pointing device is able to be manipulated by simply moving the larger forearm muscles. Furthermore, the flat surface 30 maintains the pointing device in a generally upright position, alleviating the need for the wrist to balance the pointing device during its use. These features significantly reduces stress and strain on the more delicate hand and wrist muscles.

Furthermore, the present invention also includes a selection mechanism which is coupled to the rounded surface located on the bottom portion 14. To activate the selection mechanism, the user rotates the forearm causing the subject pointing device 10 to roll onto the right or left rounded section. This eliminates the need to use independent finger movements to activate the selection mechanism.

As a result of the ergonomic improvements in the subject invention, the operator of the subject pointing device mostly recruits the larger forearm muscles, and minimizes the movements of the weaker and smaller wrist and hand muscles. This enables a user to utilize a pointing device for a longer period of time and alleviates movements which contribute to repetitive stress injuries such as carpal tunnel syndrome.

The matter set forth in the foregoing description and accompanying drawings is offered by way of illustration only and not as a limitation. While a particular embodiment has been shown and described, it will be apparent to those skilled in the art that changes and modifications may be made without departing from the broader aspects of applicant's contribution. The actual scope of the protection sought is intended to be defined in the following claims when viewed in their proper perspective based on the prior art.

I claim:

1. A pointing device comprising:
a top portion having a protuberance extending longitudinally along the top portion;
a bottom portion having a first surface and a second surface, the first surface being generally planar, the second surface being generally non-planar; and
a selection mechanism coupled to the second surface.

2. The device of claim 1, and further comprising a tongue extending from the protuberance.

3. The device of claim 2, wherein the bottom portion is frusto-spheroidal.

4. The device of claim 1, wherein the second surface is movable in a direction generally perpendicular to the first surface.

5. The device of claim 4, wherein the selection mechanism includes a pressure switch coupled to the second surface.

6. The device of claim 5, wherein the second surface is rounded.

7. The device of claim 1, and further comprising a scrolling wheel that extends through the top portion, the scrolling wheel being generally parallel to the first surface.

8. The device of claim 7, wherein the protuberance is adapted to engage a finger.

9. The device of claim 8, and further comprising a track ball mechanism extending through the first surface.

10. The device in claim 9, and further comprising a padding material connected to the top portion.

11. A pointing device comprising:
a top portion;
a bottom portion having a generally planar surface and a generally rounded surface adjacent to the planar surface; and
a selection mechanism coupled to the rounded surface.

12. The device of claim 11, wherein the planar surface occupies a central region of the bottom portion and the rounded surface surrounds the planar surface peripherally.

13. The device of claim 12, wherein the rounded surface includes a right section and a left section, and wherein the selection mechanism includes a separate pressure switch coupled to each of the sections.

14. The device of claim 13, and further comprising a protuberance extending in a generally longitudinal direction along the top portion the protuberance adapted to separate and engage a pair of adjacent fingers.

15. The device of claim 13, wherein the right and left sections are adapted to travel in a direction generally perpendicular to the planar surface.

16. A pointing device comprising:
a top portion having a longitudinally extending protuberance, the protuberance having a retaining tongue extending therefrom;
a bottom portion having a generally planar surface and a generally rounded surface peripherally surrounding the planar surface; and
a selection mechanism coupled to the rounded surface.

17. The device of claim 16, and further comprising a track ball mechanism extending through the planar surface.

18. The device of claim 17, and further comprising a scroll wheel extending from the top portion, the scroll wheel being generally parallel to the planar surface.

19. The device of claim 18, and further comprising a gel padding material connected to the top portion.

20. The device of claim 19, wherein the selection mechanism includes a pressure switch coupled to the rounded surface.
